(19) United States
(12) Patent Application Publication
(10) Pub. No.: US 2009/0291606 A1
(43) Pub. Date: Nov. 26, 2009

(54) ILLUMINATING COMPLEX COMPRISING A LIGHT SOURCE HAVING A WEB OF OPTICAL FIBRES

(75) Inventors: Delphine Malhomme, Valence (FR); Cédric Brochier, Lyon (FR); Emmanuel Deflin, Brindas (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: Brochier Technologies, Villeurbanne (FR)

(21) Appl. No.: 12/444,999

(22) PCT Filed: Oct. 12, 2007
(86) PCT No.: PCT/FR07/52141

§ 371 Date: Apr. 9, 2009

(30) Foreign Application Priority Data
Oct. 13, 2006 (FR) 0654277

(51) Int. Cl. F21V 8/00; D03D 15/00

(52) U.S. Cl. 442/301; 442/286; 442/232; 442/199

(57) ABSTRACT

An illuminating complex includes a light source having a textile web incorporating optical fibres in the warp and/or weft directions. The fibres are associated with binding yarns, and the optical fibres are capable of emitting light laterally. The textile web is attached to a rigid or semi-rigid backing, and a bonding intermediate allows the textile web to be at least partly attached in an irreversible manner to a rigid backing.

### FIELD OF THE INVENTION

The invention relates to the field of thin illuminating panels which may be in the form of a portion of a wall, ceiling or rigid or semi-rigid partition.

The invention relates more especially to an illuminating complex which is capable, in particular, of being fitted in a building or motor vehicle intended for transporting passengers such as a train or aircraft.

### DESCRIPTION OF THE PRIOR ART

Generally speaking, illuminating panels fitted into a partition comprise light sources such as fluorescent lamps concealed behind a light diffuser sheet made of frosted glass or polymethyl methacrylate (PMMA).

However, the fluorescent lamps must be fitted some distance away from the sheet in order to remain invisible through the diffuser sheet. Such panels are therefore fairly bulky at the rear of the diffuser sheet. They must also have a rear panel which is used solely to support the various electrical power supply units for the fluorescent lamps. Such panels are therefore thick and heavy.

Textile webs which comprise woven optical fibres with binding yarns that are kept tensioned by a rigid frame are also known. The woven fabrics thus formed are then treated in various ways in order to obtain uniform lateral light emission.

However, such webs cannot be arranged in direct contact with a partition. In addition, they have relatively little resistance to tearing and fire. They must therefore be installed in spaces which are protected against these various hazards.

Illuminating panels made of a non-woven web of optical fibres sandwiched between a transparent front sheet and a light reflecting rear sheet are also known. Such light sources are described, in particular, in U.S. Pat. No. 5,021,928.

Nevertheless, using a non-woven web of optical fibres poses numerous problems in terms of maintaining a uniform surface appearance when handling it before fitting it between the two sheets and when subsequently connecting the optical fibres to one or more light sources.

Not only that, the transparent front sheet has the drawback of substantially increasing the weight of the illuminating complex. The cost of manufacturing such an illuminating complex is consequently correspondingly expensive. What is more, such an illuminating panel does not make it possible to retain the special touch and feel of textiles.

### SUMMARY OF THE INVENTION

The invention relates to an illuminating complex comprising a light source having a textile web incorporating optical fibres in the warp and/or weft directions, said fibres being associated with binding yarns and said optical fibres being capable of emitting light laterally.

It is characterised in that the textile web is attached to a rigid or semi-rigid backing and in that a bonding intermediate allows the textile web to be at least partly attached in an irreversible manner to the rigid backing.

In other words, there is no air in the gap between the textile web and the rigid backing, thus improving thermal conductivity and heat dissipation. The combination of a small quantity of available oxygen, significant heat dissipation and also the high thermal resistance of the rigid backing creates a barrier effect. Such an illuminating complex can therefore be extremely fire resistant. Surprisingly, an illuminating complex which incorporates a textile web is much more fire resistant than the textile web on its own.

The bonding intermediate is chosen in order to make sure that the entire complex does not release toxic or opaque smoke and that it achieves a satisfactory classification in classification in so-called smoke tests. Like the rigid backing, the bonding intermediate can create a barrier effect which affords protection against mechanical stresses.

The textile web is bonded on a rigid or semi-rigid backing in those areas which are visible and provide illumination. In fact, in areas which are not visible, especially the edge of the web, the optical fibres must be connected to one or more light sources Consequently, the textile web is not directly attached to the rigid backing in such areas. This connection area may, depending on the particular variant, be located in the same plane as the textile web or be located to the rear of this plane, behind the rigid backing.

The bonding intermediate is selected so as to enable a user to touch the woven fabric comprising the optical fibres directly without making it possible to damage or even pull the optical fibres out.

Also, the illuminating complex thus formed has a thickness of several millimetres and can assume any kind of flat or warped shape. To achieve this, the rigid backing may, in particular, be folded or stamped by a press.

In one particular embodiment, the optical fibres can be woven with binding yarns. In other words, the binding yarns are woven in the warp and/or weft direction whereas the optical fibres are woven in the weft and/or warp direction on a loom.

Advantageously, the textile web may incorporate ground threads woven in the warp and weft directions as a plain weave.

In other words, each weft ground thread passes alternately under then over a warp thread. Such a weave makes it possible to ensure optimum mechanical cohesion of the woven fabric while encouraging good light transmission. The binding yarns are therefore woven with the ground threads.

In practice, the optical fibres can be locally attached to the ground threads by means of binding yarns with the optical fibres being positioned substantially in a plane which is parallel to the plane defined by the weave of the ground threads.

This way, the optical fibres can be held in position parallel to each other thanks to the binding yarns which are periodically woven, but not alternately woven, with the optical fibres. This type of complex bonding of binding yarns with the optical fibres is made possible in particular by a Jacquard-loom which allows individual selection of every warp thread and weft thread at any point on the woven fabric. For example, the period which separates two loops of the weave which successively cover a single optical fibre may comprise approximately ten loops of the ground threads of the weave.

In a first embodiment, the optical fibres can be in continuous contact with the bonding intermediate.

The optical fibres are thus immobilised relative to the rigid backing. The binding yarns then cover the optical fibres and protect them against external environmental stresses.

In addition, the presence of the optical diopter between the optical fibres and the bonding intermediate allows direct reflection of a significant quantity of luminous energy, thus increasing the intensity of the lateral illumination produced by the complex.

In this case, the binding yarns can be in substantially point contact with the bonding intermediate.

This way, the binding yarns have translational mobility parallel to the surface defined by the rigid backing. This arrangement makes it possible to increase tear resistance and improve the protection of the optical fibres by the binding yarns.

Also, in order to allow maximum light transmission, the weave formed by the binding yarns can be breathable. For example, the distance between two successive binding yarns in the weft or warp directions can exceed two thirds of the diameter of these binding yarns, whereas the diameter of the binding yarns is less than the radius of the optical fibres.

In a first embodiment, the binding yarns can be in substantially continuous contact with the bonding intermediate.

In this case, the optical fibres provide direct lateral illumination without being masked by the binding yarns. Such an arrangement allows maximum luminous energy transmission.

In contrast to the first embodiment, the binding yarns can then be very tightly spaced so as to form a screen which makes it possible to reflect light.

Advantageously, the illuminating complex may comprise an attached protective layer which faces the optical fibres.

In other words, for certain particular applications which demand a high level of protection, one can position a protective layer close to or even in contact with the optical fibres, this protective layer preferably being transparent or translucent in order to let as much light through as possible. This protective layer may consist of a breathable material such as a woven fabric, mesh, netting or tulle or, more generally speaking, even a non-woven fabric. The protective layer can then be attached to the optical fibres by another bonding intermediate. Such a transparent protective layer can, in particular, be formed by a sheet of glass, polymethyl methacrylate (PMMA) or polycarbonate (PC).

In another variant, the protective layer can also be obtained by subjecting the illuminating complex to a surface treatment, in particular a process involving coating, spraying or polymerisation, especially a process of the resin or gel coat type.

In practice, the rigid backing may comprise a reflecting surface to which the bonding intermediate is attached.

In other words, the reflecting surface is used to reflect and diffuse light towards the fabric-side of the woven fabric. This reflecting surface is advantageously coloured white but may be made according to various embodiments as an independent element or be the actual backing itself if the latter is coloured white in the mass, for instance a polycarbonate sheet.

In one particular embodiment, the reflecting surface can be attached to the rigid backing.

In fact, this reflecting surface can also consist of a paint film, an anodised metallic layer, a pressure-sensitive adhesive film or even foam or a white-coloured textile.

Also, the rigid backing can be made of a material chosen from a group comprising metals, polymers and composites.

Such materials are actually light and very rigid. These materials also make it possible to give the illuminating complex considerable resistance to heat or fire and ensure it dissipates stored heat very quickly. These materials offer good thermal conductivity.

Advantageously, the optical fibres can each be formed by a core clad in a fluorinated polymer.

In practice, the core of the optical fibres can be made of a material chosen from a group comprising polymethyl methacrylate (PMMA) and polycarbonate (PC).

In one particular embodiment, the ground threads can be made of a material chosen from a group comprising natural, synthetic or artificial yarns or fibres, especially wool, aramide, polyamide, chlorofibres, polyester and cotton.

Thus, the optical fibres can be woven with binding yarns which have good resistance to fire and mechanical stresses alike. Such yarns include, in particular, those marketed under the Trevira®, Nomex® and Kermel® brand names or combinations of these yarns with other textile yarns in order to give the textile thus formed other properties or to reduce its overall cost.

In addition, the bonding intermediate can be white in colour and contribute towards reflection. In another embodiment, the bonding intermediate can also be transparent.

Preferably, positioning the bonding intermediate on the rigid and sometimes curved surfaces can be made easier if the latter is in the form of a double-sided cold-rollable adhesive or by using a sprayed liquid adhesive.

This bonding intermediate can also contribute towards the barrier effect already produced by the rigid backing and is consequently heat resistant. Finally, it is preferably free of toxic elements capable of modifying the “smoke” classification of the complex.

### BRIEF DESCRIPTION OF THE DRAWINGS

In order that the way in which the invention is implemented and its resulting advantages may more readily be understood, the following description of an embodiment is given, merely by way of example, reference being made to the accompanying drawings.

FIG. 1 is a perspective view of the location of a textile web before it is incorporated in an illuminating complex in accordance with the invention;

FIG. 2 is a front view of the back of such a textile web;

FIGS. 3 and 4 are cross-sectional views of two alternative ways of positioning the textile web on a rigid backing.

### DETAILED DESCRIPTION OF THE INVENTION

As stated above, the invention relates to an illuminating complex made up of a textile web which incorporates optical fibres arranged in the warp or weft directions and woven with binding yarns.

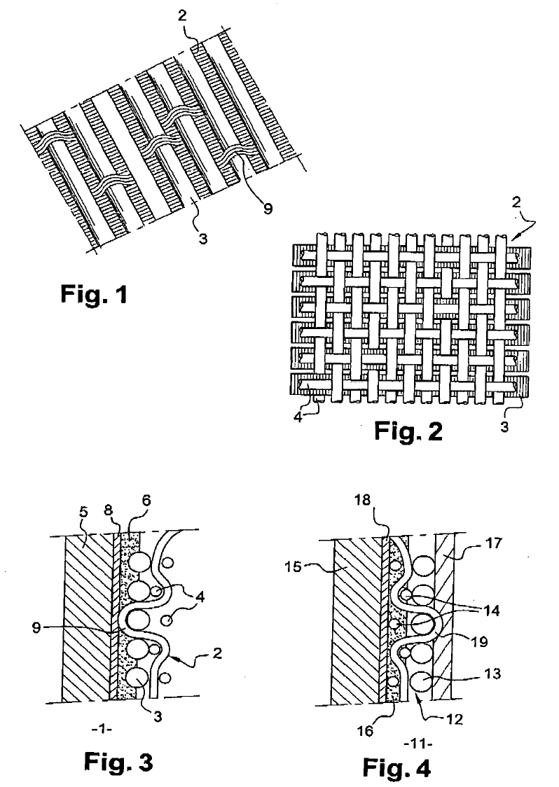

As shown in FIG. 1, the illuminating complex comprises a textile web (2) in which the optical fibres (3) are woven with binding yarns (4). Depending on the particular embodiment, the optical fibres (3) or the binding yarns (4) can be arranged either in the warp or the weft direction. In the case shown, binding yarns (4) are positioned both in the warp and weft directions, whereas the optical fibres (3) are arranged either in the weft direction or the warp direction.

Also and in order to improve the lighting characteristics of the illuminating complex which incorporates such a textile web (2), binding yarns (4) can be locally woven with the optical fibres (3). The binding yarns (4) can be interwoven as a “fabric” type weave in order to create empty gaps capable of letting through the luminous energy emitted by the optical fibres (3). With this particular arrangement, optical fibres (3) are then arranged substantially in a plane which is parallel to that defined by the binding yarns (4).

As shown in FIG. 2, the cross section of optical fibres (3) can exceed that of binding yarns (4) in order to allow transfer of luminous energy at the level of the rear panel of the fabric defined by the binding yarns (4). For instance, optical fibres (3) can have a diameter which is twice that of binding yarns (4).

What is more, in order to let as much light as possible through the weave formed by binding yarns (4), they can, for instance, be spaced apart a distance which exceeds two thirds of the diameter of the binding yarns (4).

The textile web (2) thus formed is then attached to a rigid backing and bonded by means of a bonding intermediate. It is also possible to arrange the textile web facing the rigid backing with its fabric-side and back faces as shown in FIGS. 3 and 4.

This way, and as shown in FIG. 3, the illuminating complex is formed by a textile web (2) the fabric-side face of which cooperates with bonding intermediate (6). In this case, optical fibres (3) are in continuous contact with bonding intermediate (6). This bonding intermediate (6) also allows direct reflection of the light emitted by optical fibres (3) in a direction which is opposite to that of rigid backing (5).

Illuminating complex (1) may nevertheless comprise a reflecting surface (8) which can either be attached to rigid backing (5) or be formed directly by this backing (5) if the latter is made, in particular, as a polycarbonate sheet coloured white in the mass or even even an anodised aluminium sheet.

The binding yarns (4) can then be used to protect the illuminating elements formed by optical fibres (3). They also make it possible to give the illuminating complex (1) the distinctive touch and feel of a textile material.

As shown in FIG. 4, illuminating complex (11) may comprise a textile web (12) attached by its back to a rigid backing (15). Bonding intermediate (16) is then used to attach binding yarns (14) to rigid backing (15). Optical fibres (13) can then emit light radially in a direction which is opposite to that of rigid backing (15) and bonding intermediate (16) without being masked by a weave formed by binding yarns (14).

For certain applications, in particular in order to prevent physical damage to optical fibres (13), a protective layer (17) can be attached facing optical fibres (13). This protective layer (17) can assume various forms and, in a first embodiment, is in the form of a breathable textile in order to give a textile touch and feel to the illuminating complex (11) while letting as much light as possible through the openings in the textile.

In a second embodiment, protective layer (17) can also be made of a solid transparent material and be in the form of a rigid sheet made of a material such as glass, PMMA or polycarbonate which is mechanically assembled facing optical fibres (13).

In a third embodiment, protective layer (17) can also be attached so that it is intimately bonded to optical fibres (13) by means of a spray coating process, especially a process for applying a resin which is commonly referred to as a “gel coat”.

What is more, fire-resistance comparison studies have been conducted using special-purpose measuring tools in accordance with the applicable standards concerning flexible and rigid materials, NF F 92 503 and NF 92 501, railway applications NF 16 101, technical specification SNCF/RATP STM-S-001 and building P 92 502, respectively.

A complex was produced, by way of example, using a rigid metallic backing, an MSP (Modified Silicone Polymer)-based bonding intermediate, optical fibres with a PC core and ground threads made of a flame-resistant polyester such as Trevira® CS in particular.

The textile web thus formed may comprise, in the weft direction, an alternation of 17 optical fibres and 17 ground threads per centimetre made of “non-fire” polyester such as threads marketed under the Trevira® CS brand name and, in the warp direction, 50 ground threads per centimetre made of Trevira® CS brand polyester for example. The size of the ground threads is 167 dtex.

This complex successfully withstood the applicable fire-resistance tests and achieved the highest fire-resistance and smoke behaviour classification for materials intended for use in railway and building construction applications.

In fact, the complex has a class M1 fire-behaviour rating in accordance with Standards NF P 92 501 and P 92 502.

The complex has a class F1 smoke-behaviour rating in accordance with Standards NF X 10-702 (1,2,3,4,5) and NF X 70-100.

The above description makes it apparent that the illuminating complex in accordance with the invention has many advantages, in particular:

It makes it possible to produce an illuminating surface which is rigid, light and thin;

It can be used as an actual partition or light ceiling without the need for any assembly operations;

It has extremely good mechanical strength properties;

It makes it possible to dissipate heat very quickly, can withstand fire and does not release any toxic smoke, depending on the nature of its constituent materials.

1. An illuminating complex comprising a light source having a textile web incorporating optical fibres in the warp and/or weft directions, said optical fibres being associated with binding yarns, said optical fibres being capable of emitting light laterally, wherein the textile web is attached to a rigid or semi-rigid backing, and wherein a bonding intermediate allows the textile web to be at least partly attached in an irreversible manner to the backing.

2. The complex as claimed in claim 1, wherein the optical fibres are woven with the binding yarns.

3. The complex as claimed in claim 2, wherein the textile web incorporates ground threads arranged in the warp direction and in the weft direction as a plain type weave.

4. The complex as claimed in claim 3, wherein the optical fibres are locally attached to the ground threads by means of the binding yarns with the optical fibres being positioned substantially in a plane, which is parallel to the plane defined by the weave of the ground threads.

5. The complex as claimed in claim 1, wherein the optical fibres are in continuous contact with the bonding intermediate.

6. The complex as claimed in claim 1, wherein the binding yarns are substantially in point contact with the bonding intermediate.

7. The complex as claimed in claim 3, wherein the ground threads are in substantially continuous contact with the bonding intermediate.

8. The complex as claimed in claim 6 further comprising a protective layer attached facing the optical fibres.

9. The complex as claimed in claim 1, wherein the backing comprises a reflecting surface to which the bonding intermediate is attached.

10. The complex as claimed in claim 8, wherein the reflecting surface is attached to said rigid backing.

11. The complex as claimed in claim 1, wherein the backing is made of a material chosen from a group comprising metals, polymers and composites.

12. The complex as claimed in claim 1, wherein the optical fibres are each formed by a core clad in a fluorinated polymer.

13. The complex as claimed in claim 11, wherein the core of the optical fibres is made of a material chosen from a group comprising polymethyl methacrylate (PMMA) and polycarbonate (PC).

14. The complex as claimed in claim 1, wherein the ground threads are made of a material chosen from a group comprising natural, artificial or synthetic yarns or fibres.
